(19) United States
(12) Patent Application Publication
(10) Pub. No.: US 2015/0040222 A1
(43) Pub. Date: Feb. 5, 2015

(54) DETECTING AND REACTING TO INAPPROPRIATE EQUIPMENT AND PROGRAMMING IN A COMPUTER SYSTEM WITHOUT GENERATING ALERTS TO UNAUTHORIZED USERS OF THE DETECTION

(71) Applicant: International Business Machines Corporation, Armonk, NY (US)

(72) Inventors: Richard H. Boivie, Monroe, CT (US); Robert R. Friedlander, Southbury, CT (US); James R. Kraemer, Santa Fe, NM (US); Jeb Linton, Manassas, VA (US)

(73) Assignee: International Business Machines Corporation, Armonk, NY (US)

(21) Appl. No.: 13/955,174

(22) Filed: Jul. 31, 2013

(51) Int. Cl. H04L 29/06; H04L 12/24

(52) U.S. Cl. CPC H04L 63/1416; H04L 41/0813
USPC 726/23

(57) ABSTRACT

A method, computer program product and system of detecting changes in hardware, software, or programming of a device in a computer system by a computer in the system coupled to the device through a network, without generating alerts or alerting unauthorized users of the detection of the changes.

### BACKGROUND

The present invention relates to security of a complex computer system, and more specifically to detecting and reacting to inappropriate equipment and/or programming of a device within a computer system without generating alerts to the operating system or otherwise notifying unauthorized users or parties of the detection or reaction to the discovery of the inappropriate equipment or programming.

Complex computer systems are common in many sectors and are frequently distributed over heterogeneous networks, and are driven by many diverse requirements on performance, real-time behavior, fault tolerance, security, adaptability, development time and cost, long life concerns, and other areas. Such requirements frequently conflict, and the satisfaction of all of these requirements therefore requires managing the trade-off among them during system development and throughout the entire system life.

In complex computer systems, such as systems controlling airplanes, chemical production lines, electric transmission lines, there is a possibility for the introduction of malevolent intelligent devices, for example containing a processing element or smart sensing element, that are counterfeit, sabotaged, inappropriate for the intended use and/or even expired. Furthermore, the intelligent devices may be further used to alter programming of devices within the complex computer system. The reasoning behind an unauthorized user for introducing such malevolent programming or equipment is often difficult to determine and appropriate action by the complex computer system to remedy the intrusion may be suppressed by the unauthorized user if the unauthorized user detects an alert from the detection of the malevolent intelligent devices or a reaction from the complex computer system.

Public key cryptography is a cryptography system that uses two separate keys to encrypt data, a public key and a private key. The public key, which can be freely distributed, is related mathematically to the private key. The public key is used to lock or encrypt data or plain text and the private key unlocks or decrypts the encrypted data. Because of the huge number of ways the private key and public key can be related, mere knowledge of the public key is not sufficient to allow decryption, and only the person or computer possessing the private key can therefore decrypt the encrypted data.

### SUMMARY

According to one embodiment of the present invention a method of detection of changes in hardware, software, or programming of a device in a computer system by a computer in the computer system coupled to the device through a network, without generating alerts or alerting unauthorized users of the detection of the changes. The method comprising the steps of: the computer coupled to the device receiving at least one encrypted message from the device, the message having at least data regarding a change of hardware, software, or programming of the device; the computer decrypting the message from the device to obtain the data regarding a change of hardware, software, or programming of the device from a device; the computer comparing an existing configuration of the programming, software and hardware of the device to the data regarding the change of hardware, software, or programming of the device from the message to obtain differences between the existing configuration of the device and the data regarding the change of hardware, software, or programming of the device. If differences are present between the existing configuration of the device and the data regarding the change of hardware, software, or programming of the device, the computer: determining whether additional messages are to be sent to the device, and if additional messages are to be sent: the computer generates and sends an encrypted message approving the change to the device, such that change to the device takes place; and the computer updates the existing configuration to include the approved changes.

According to another embodiment of the present invention a computer program product for detection of changes in hardware, software, or programming of a device in a computer system by a computer in the computer system coupled to the device through a network, without generating alerts or alerting unauthorized users of the detection of the changes. The computer program product comprising: one or more computer-readable, tangible storage devices; program instructions, stored on at least one of the one or more storage devices, for the computer to receive at least one encrypted message from the device, the message having at least data regarding a change of hardware, software, or programming of the device; program instructions, stored on at least one of the one or more storage devices for the computer, to decrypt the message from the device to obtain the data regarding a change of hardware, software, or programming of the device from a device; program instructions, stored on at least one of the one or more storage devices for the computer, to compare an existing configuration of the programming, software and hardware of the device to the data regarding the change of hardware, software, or programming of the device from the message to obtain differences between the existing configuration of the device and the data regarding the change of hardware, software, or programming of the device. If differences are present between the existing configuration of the device and the data regarding the change of hardware, software, or programming of the device, program instructions, stored on at least one of the one or more storage devices for the computer, to: determine whether additional messages are to be sent to the device, and if additional messages are to be sent: program instructions, stored on at least one of the one or more storage devices for the computer, to generate and send an encrypted message approving the change to the device, such that change to the device takes place; and program instructions, stored on at least one of the one or more storage devices for the computer, to update the existing configuration to include the approved changes.

According to another embodiment of the present invention, a system for detection of changes in hardware, software, or programming of a device in a computer system by a computer in the computer system coupled to the device through a network, without generating alerts or alerting unauthorized users of the detection of the changes. The system comprising: one or more processors, one or more computer-readable memories and one or more computer-readable, tangible storage devices; program instructions, stored on at least one of the one or more storage devices for execution by at least one of the one or more processors via at least one of the one or more memories for the computer, to receive at least one encrypted message from the device, the message having at least data regarding a change of hardware, software, or programming of the device; program instructions, stored on at least one of the one or more storage devices for execution by at least one of the one or more processors via at least one of the one or more memories for the computer, to decrypt the message from the device to obtain the data regarding a change of hardware, software, or programming of the device from a device; program instructions, stored on at least one of the one or more storage devices for execution by at least one of the one or more processors via at least one of the one or more memories for the computer, to compare an existing configuration of the programming, software and hardware of the device to the data regarding the change of hardware, software, or programming of the device from the message to obtain differences between the existing configuration of the device and the data regarding the change of hardware, software, or programming of the device. If differences are present between the existing configuration of the device and the data regarding the change of hardware, software, or programming of the device, program instructions, stored on at least one of the one or more storage devices for execution by at least one of the one or more processors via at least one of the one or more memories for the computer, to: determine whether additional messages are to be sent to the device, and if additional messages are to be sent: program instructions, stored on at least one of the one or more storage devices for execution by at least one of the one or more processors via at least one of the one or more memories for the computer, to generate and send an encrypted message approving the change to the device, such that change to the device takes place; and program instructions, stored on at least one of the one or more storage devices for execution by at least one of the one or more processors via at least one of the one or more memories for the computer, to update the existing configuration to include the approved changes.

### BRIEF DESCRIPTION OF THE SEVERAL VIEWS OF THE DRAWINGS

FIG. 1 depicts an exemplary diagram of a possible data processing environment in which illustrative embodiments may be implemented.

FIGS. 2-3 show a method of a first embodiment of detecting and reacting to inappropriate or malevolent equipment or programming in a complex computer system without generating alerts or alerting unauthorized users of the detection of the malevolent device or programming through the use of an encrypted communications network.

FIGS. 4-5 show a method of a second embodiment of detecting and reacting to inappropriate or malevolent equipment or programming in a complex computer system without generating alerts or alerting unauthorized users of the detection of the malevolent device or programming by sending encrypted messages either including alert information or not from devices within the system at an interval consistent with the standard traffic of the communications network of the complex computer system.

FIG. 6 depicts another exemplary diagram of a possible data processing environment in which illustrative embodiments may be implemented.

FIG. 7 illustrates internal and external components of a client computer and a server computer in which illustrative embodiments may be implemented.

### DETAILED DESCRIPTION

The illustrative embodiments recognize that malevolent equipment or devices are devices that preferably contain a processing element or smart sensing element that can trigger inappropriate execution of programming or software or the installation of inappropriate equipment.

The illustrative embodiments recognize that a complex computer system is a system in which each of the devices present within the system has a separate Internet Protocol address (IP address) that is used for communication, as well as host or network interface identification and location addressing. The devices within the complex computer system have the ability to use encryption and decryption techniques in order to send and receive messages over a communications network, which may be secured and encrypted or unsecured.

The illustrative embodiments recognize that any changes to the existing configuration of a device in a network may be detrimental or possibly malevolent and can be triggered by malevolent intelligent devices. The malevolent intelligent device may trigger or instigate a change that may be a software change including new software added, software updated or software deleted. The change may be an alteration of the programming of the device. The change may be an addition of hardware, removal of hardware or any other change to the hardware.

The illustrative embodiments recognize that in specific industries that have complex systems controlling various tasks, a slight alteration may have significant consequences.

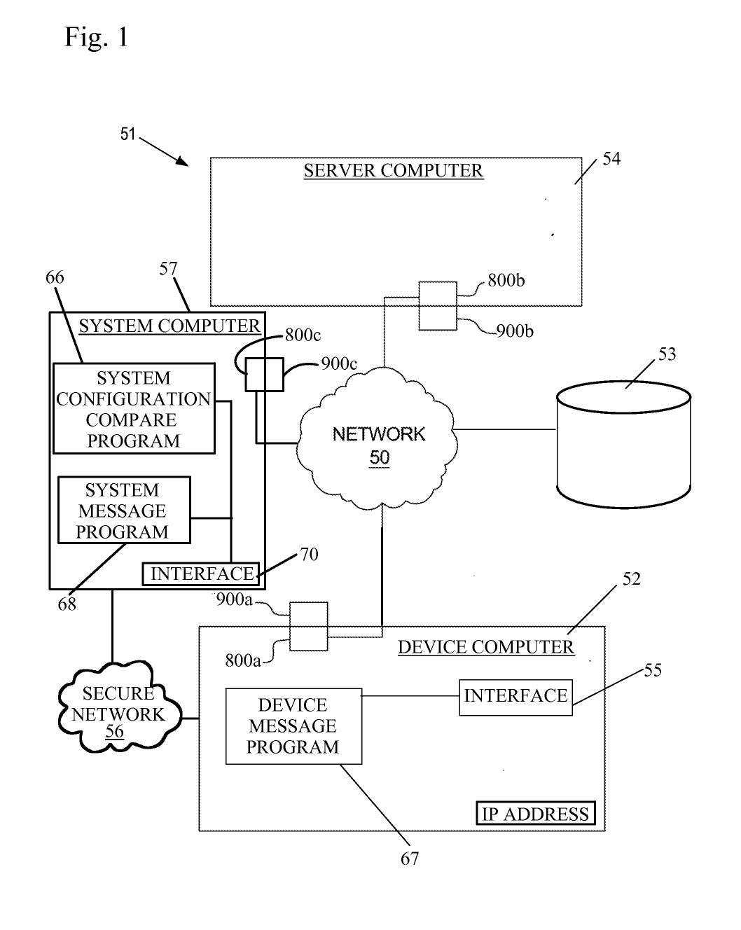

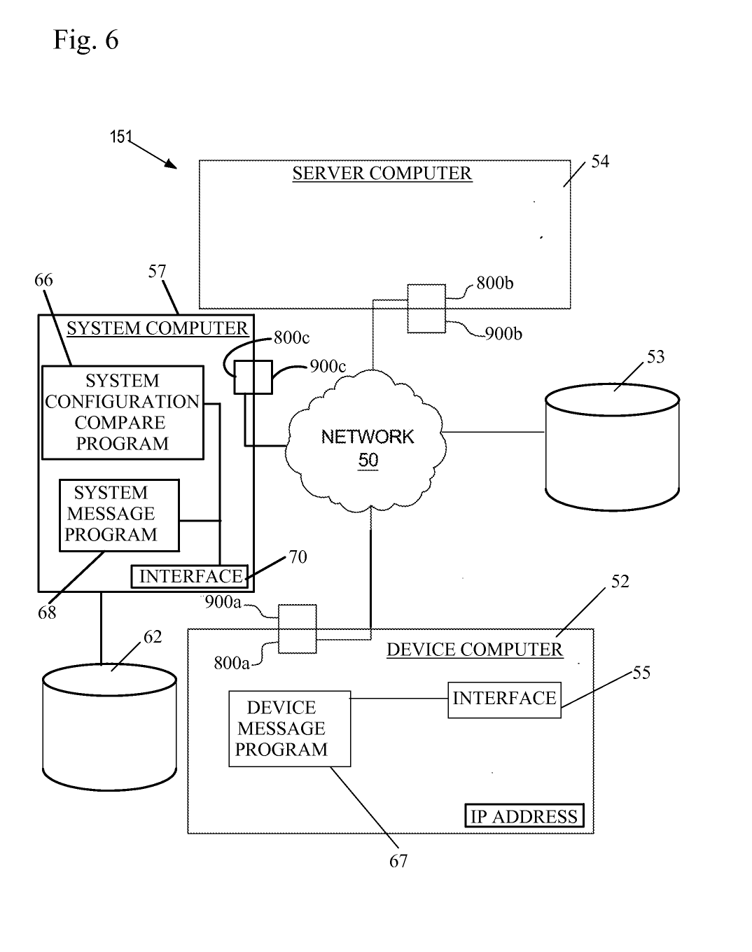

FIGS. 1 and 6 are exemplary diagrams of possible data processing environments provided in which illustrative embodiments may be implemented. It should be appreciated that FIGS. 1 and 6 are only exemplary and are not intended to assert or imply any limitation with regard to the environments in which different embodiments may be implemented. Many modifications to the depicted environments may be made. FIGS. 1 and 6 show simplified views of a complex computer system. It should be noted that only one device is shown, but numerous devices would be present. FIG. 6 is discussed further below.

Referring to FIG. 1, network data processing system 51 is a network of computers or devices in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables. An additional secured, encrypted network 56 is present for the communication between the devices and the system computer 57 regarding any changes to the existing configuration of the device. Network 56 may include connections, such as wire, wireless communication links, or fiber optic cables.

In the depicted example, device computer 52 of a device, repository 53, a server computer 54, and a system computer 57 connect to network 50. Any communication between the device computers 52 and a system computer 57 occurs through a secured, encrypted network 56. The communication between the device computer 52 and the system computer 57 is concerned with any changes to the existing configuration of the device computer 52. The communication may occur between respective controllers or computers within the device or device computers 52 and the system computer 57.

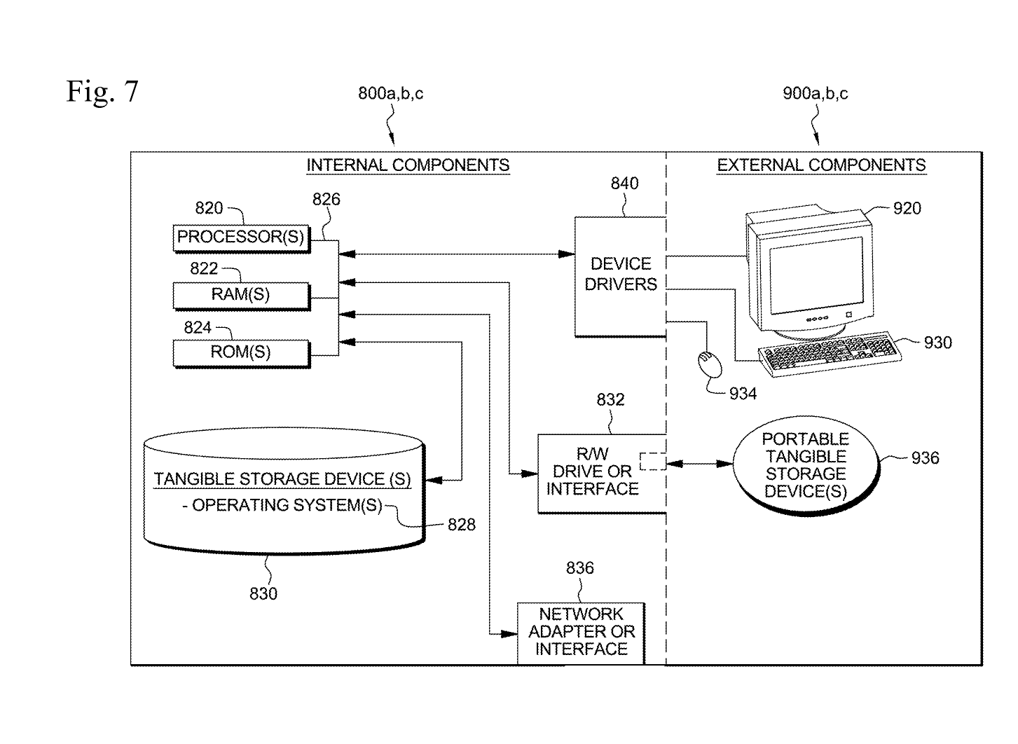

In other exemplary embodiments, network data processing system 51 may include additional device computers, storage devices, server computers, and other devices not shown. Each of the devices and computers preferably have their own IP address as well as a device message program, 67 for encrypting and decrypting messages. The device computer 52 includes a set of internal components 800a and a set of external components 900a, further illustrated in FIG. 7. Device computer 52 may be, for example, a mobile device, a cell phone, a personal digital assistant, a netbook, a laptop computer, a tablet computer, a desktop computer, or any other type of computing device.

In the depicted example, server computer 54 provides information, such as boot files, operating system images, and applications to the device computer 52 or the system computer 57. Server computer 54 includes a set of internal components 800b and a set of external components 900b illustrated in FIG. 7 and may also include the components shown in FIG. 1. Alternatively, the server computer 54 may perform the functions of the system computer 57.

The system computer 57 includes an interface 70. The interface 70 can be, for example, a command line interface, a graphical user interface (GUI), or a web user interface (WUI). The interface 70 may be used, for example for monitoring devices or the comparison of the change of a device to an existing configuration through the system configuration compare program 66, as well as for indicating specific messages to be sent to the device computers 52 or notifying an authorized user through the system message program 68. Any device computers 52 that communicate with the system computer 57 are identified through their IP address.

Program code, existing device configurations, and programs such as a device message program 67, system configuration compare program 66, and the system message program 68 may be stored on at least one of one or more computer-readable tangible storage devices 830 shown in FIG. 7, on at least one of one or more portable computer-readable tangible storage devices 936 as shown in FIG. 7, on repository 53 connected to network 50, or downloaded to a data processing system or other device for use.

For example, program code, existing device configurations, and programs such as a device message program 67, system configuration compare program 66, and the system message program 68 may be stored on at least one of one or more tangible storage devices 830 on server computer 54 and downloaded to device computer 52 or the system computer 57 over network 50 for use on device computer 52 or the system computer 57. Alternatively, server computer 54 can be a web server, and the existing device configurations and programs such as a device message program 67, system configuration compare program 66, and the system message program 68 may be stored on at least one of the one or more tangible storage devices 830 on server computer 54 and accessed on the device computer 52 or the system computer 57. In other exemplary embodiments, the program code, existing device configurations and programs such as a device message program 67, system configuration compare program 66, and the system message program 68 may be stored on at least one of one or more computer-readable tangible storage devices 830 on device computer 52 or the system computer 57 or distributed between two or more servers.

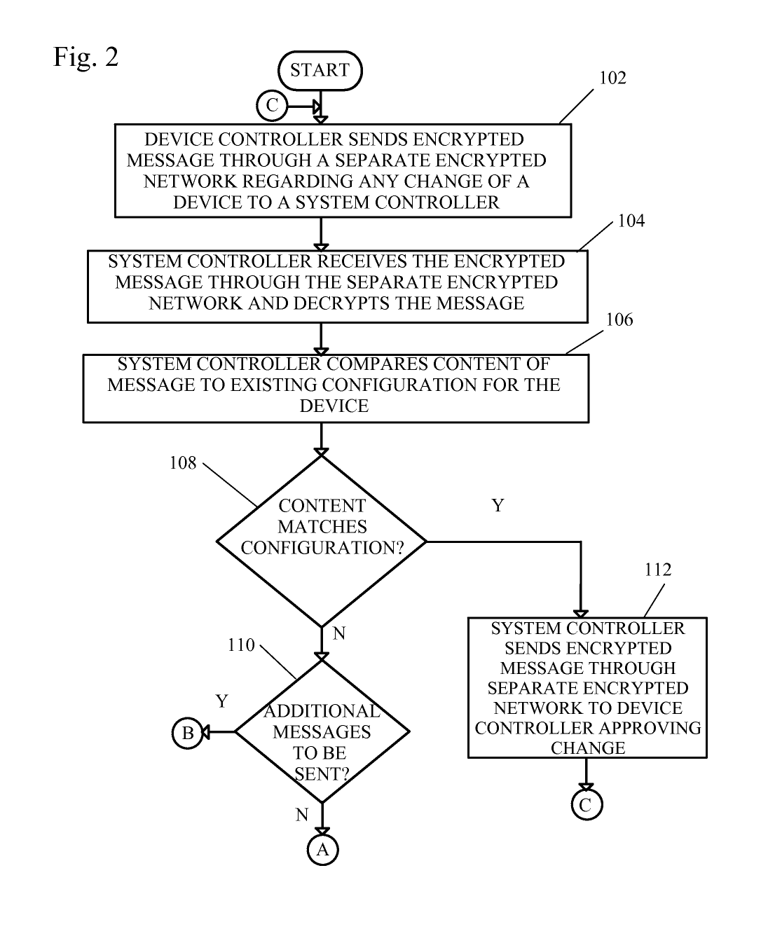

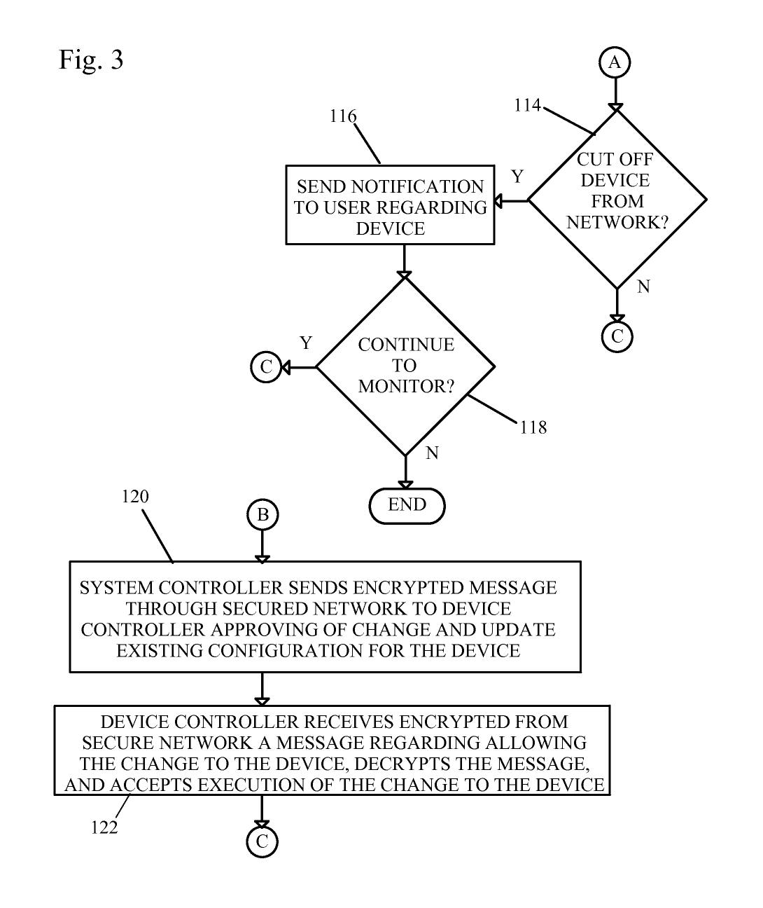

FIGS. 2-3 show a method of a first embodiment of detecting and reacting to inappropriate or malevolent equipment or programming in a complex computer system without generating alerts or alerting unauthorized users of the detection of the malevolent device or programming through the use of an encrypted communications network according to an illustrative embodiment.

In a first step, a controller of a device, or a computer in the device, sends an encrypted message regarding a change to the existing configuration of the device through a separate, secure encrypted network, for example network 56, to a system computer through the device message program 67 (step 102). The change may be the result of a malevolent or inappropriate intelligent device accessing and attempting to alter the device. The device may be, for example, device computer 52, and the system computer may be, for example be part of a system computer 57, as shown in FIG. 1. It should be noted that the secure network 56 is separate from the network 50 of the system, and that the secured network 56 is preferably encrypted and used for messages regarding changes to the existing configuration of the devices within the system. The controller of the device or the computer of the device may encrypt the message through the use of various conventional encryption techniques such as public key cryptography.

A system computer, for example system computer 57, of the complex computer system receives the encrypted message from the device through the secure network 56 and decrypts the message (step 104), for example through the system message program 68 and in one embodiment through a system controller of the system computer 57. The system computer 57 decrypts the message through various conventional decryption techniques. The content of the message is preferably specific to a change of the configuration of the device, although other information may also be included within the message, for example operating status.

The system computer compares the existing configuration of the device, for example device computer 52, to the data content of the decrypted message regarding the change (step 106), for example through the system configuration compare program 66.

If the data content regarding a change to the device matches the existing configuration data for the device (step 108), then the system computer 57 sends an encrypted message approving the change though the secure network to the device (step 112), for example through the system message program 68. This allows the change to be executed or take place to the device. The matching of the content of the change to the device and the existing configuration for the device may occur, for example, when there was a scheduled change that had been approved and the configuration of the device was updated prior to a technician altering the device.

The method then continues to step 102 of the device sending an encrypted message through a secure network regarding any change to a system computer.

If the data content regarding a change to the device does not match the existing configuration data for the device (step 108), and it is determined, based on the content, that different additional messages are to be sent to the device (step 110), then an encrypted message is sent through the secured network to the device approving the change. The system computer then updates the existing configuration data of the device and stores the configuration in the repository (step 120), for example repository 53. The message is preferably sent using the system message program 68. The system configuration compare program 66 preferably updates and stores the updated configuration of the device.

The device receives the encrypted message through the secure network, decrypts the message, and allows the change to the device to be executed (step 122). A controller or computer of the device may receive and decrypt the message from the system computer through the device message program 67. The decryption of the message may take place using conventional encryption/decryption techniques. The method then continues to step 102 of the device sending an encrypted message through a secure network regarding any change to the system computer.

If the content regarding a change to the device does not match the existing configuration data for the device (step 108), and it is determined based on the data content that does not match the existing configuration data, that no additional messages are to be sent to the device (step 110), and that the device is to be cut from the network data processing system or complex system 51 (step 114), then a notification is sent to an authorized user regarding the change to the device (step 116) to allow further investigation to take place. The notification may be encrypted using conventional encryption techniques.

If the system computer is still going to monitor the device (step 118), the method returns to step 102 of the device sending an encrypted message through a secure network regarding any change to the system computer. This step may for example take place if the system computer is going to monitor what changes are being requested for execution by or for the device without alerting an unauthorized party or user.

If the system computer is not going to monitor the device (step 118), the method ends.

If the data content regarding a change to the device does not match the existing configuration data for the device (step 108), and it is determined based on the data content that does not match the existing configuration data of the device, that no additional messages are to be sent to the device (step 110), and that the device is not to be cut or removed from the network data processing system or complex system (step 114), then the method returns to step 102 of the device sending an encrypted message through a secure network regarding any change to the system computer.

FIG. 6 shows another exemplary diagram of a possible data processing environment in which illustrative embodiments may be implemented. The difference between this data processing environment and that of the environment shown in FIG. 1 is the lack of the secured, encrypted communication network 56. Instead, all communication between the device computers 52 and the system computers 57 occurs through encrypted messages that are sent through the network with regular or normal network traffic to disguise a frequency of messages being sent to defeat traffic analysis. In order to do this, encrypted messages are sent at a determined frequency or burst at a regular interval. Not all of the encrypted messages being sent between the system computer 57 and the device computers 52 include information regarding a change to the existing configuration of the device computer 52. However, the same physical amount of information may be sent in each message, such that there is no discernible difference between any of the encrypted messages being sent between the system computer 57 and the device computers 52 at any time, therefore no alert or indication is apparent to unauthorized users of the discovery of malevolent intelligent devices relative to the complex computer system. The communication may occur between respective controllers or computers within the device or device computers 52 and the system computer 57.

Referring to FIG. 6, network data processing system 151 is a network of computers or devices in which illustrative embodiments may be implemented. Network data processing system 151 contains network 50, which is the medium used to provide communication links between various devices and computers connected together within network data processing system 151. Network 50 may include connections, such as wire, wireless communication links, or fiber optic cables.

In the depicted example, device computer 52 of a device, repository 53, a server computer 54, and a system computer 57 connect to network 50. An additional repository 62 is connected to the system computer 57.

In other exemplary embodiments, network data processing system 51 may include additional device computers, storage devices, server computers, and other devices not shown. Each of the devices and computers preferably have their own IP address as well as a device message program, 67 for encrypting and decrypting messages. The device computer 52 includes a set of internal components 800a and a set of external components 900a, further illustrated in FIG. 7. Device computer 52 may be, for example, a mobile device, a cell phone, a personal digital assistant, a netbook, a laptop computer, a tablet computer, a desktop computer, or any other type of computing device.

In the depicted example, server computer 54 provides information, such as boot files, operating system images, and applications to the device computer 52 or the system computer 57. Server computer 54 includes a set of internal components 800b and a set of external components 900b illustrated in FIG. 7 and may also include the components shown in FIG. 7. Alternatively, the server computer 54 may perform the functions of the system computer 57.

The system computer 57 includes an interface 70. The interface 70 can be, for example, a command line interface, a graphical user interface (GUI), or a web user interface (WUI). The interface 70 may be used, for example for monitoring devices or the comparison of the change of a device to an existing configuration through the system configuration compare program 66, as well as for indicating specific messages to be sent to the device computers 52 or notifying an authorized user through the system message program 68. Any device computers 52 that communicate with the system computer 57 are identified through their IP address. The system computer 57 is also connected to a repository 62 which may contain public keys and encrypted existing configuration data for each of the devices of the complex computer system. Alternatively, separate repositories may be used to separately store the public keys from the encrypted existing configuration data.

Program code, existing device configurations, and programs such as a device message program 67, system configuration compare program 66, and the system message program 68 may be stored on at least one of one or more computer-readable tangible storage devices 830 shown in FIG. 7, on at least one of one or more portable computer-readable tangible storage devices 936 as shown in FIG. 7, on repository 53 connected to network 50, or downloaded to a data processing system or other device for use.

For example, program code, existing device configurations, and programs such as a device message program 67, system configuration compare program 66, and the system message program 68 may be stored on at least one of one or more tangible storage devices 830 on server computer 54 and downloaded to device computer 52 or the system computer 57 over network 50 for use on device computer 52 or the system computer 57.

Alternatively, server computer 54 can be a web server, and the existing device configurations and programs such as a device message program 67, system configuration compare program 66, and the system message program 68 may be stored on at least one of the one or more tangible storage devices 830 on server computer 54 and accessed on the device computer 52 or the system computer 57.

In other exemplary embodiments, the program code, existing device configurations and programs such as a device message program 67, system configuration compare program 66, and the system message program 68 may be stored on at least one of one or more computer-readable tangible storage devices 830 on device computer 52 or the system computer 57 or distributed between two or more servers.

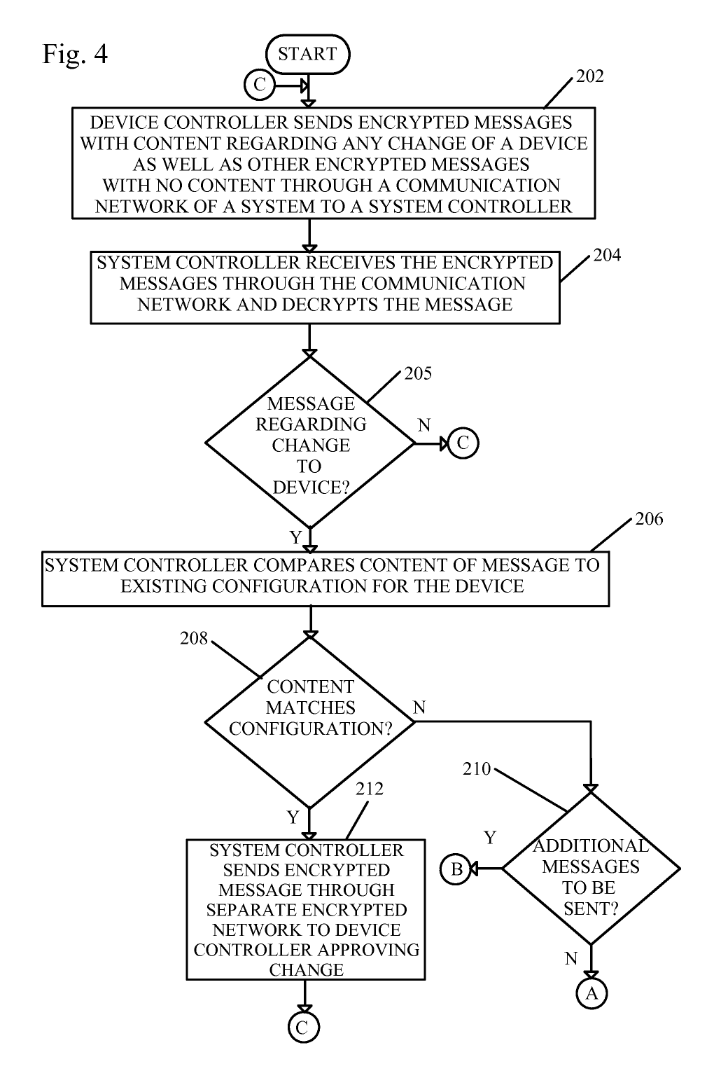

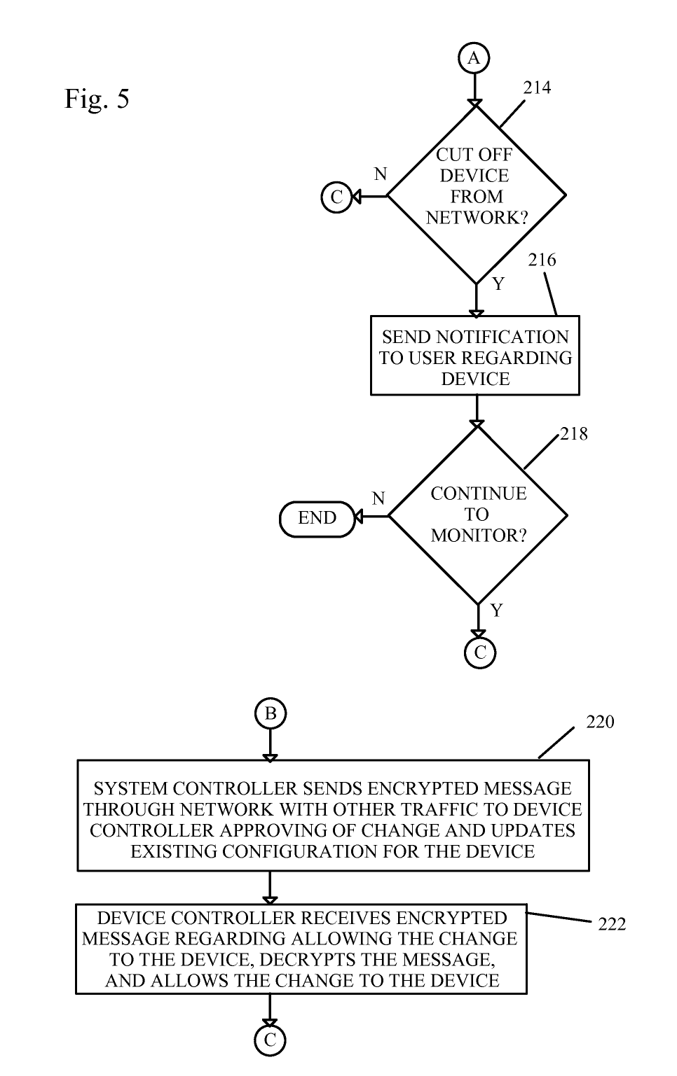

FIGS. 4-5 show a method of detecting and reacting to inappropriate or malevolent equipment or programming in a complex computer system without generating alerts or alerting unauthorized users of the detection of the malevolent device or programming by sending encrypted messages either including alert information or not from devices within the system at an interval consistent with the standard traffic of the network of the complex computer system according to another illustrative embodiment.

In a first step, a controller of a device, or a computer in the device, sends at least one encrypted message through a network, for example network 56, to a system computer through the device message program 67 (step 202). The device may be for example device computer 52 and the system computer may for example be the system computer 57 as shown in FIG. 1. The device may encrypt the message through the use of various conventional encryption techniques such as public key cryptography.

If public key cryptography is used, a generated public key is necessary for the system computer 57 and is related to a private key held by the device or device computer 52 as discussed above. In an exemplary embodiment, the system computer 57 will have respective public keys relating to all of the devices 52 of the complex system 151, and the public keys will be stored in a repository 62, indexed by some identifying information related to the devices, for example IP address. When the system computer receives an encrypted message from the device 52, the system computer 57 will use the system computer's private key to decrypt the message.

At least some of the encrypted messages include changes to the device. The encrypted message with data regarding a change to the device may also be sent with other encrypted messages from the device at an interval from the device that would not raise suspicion of an unauthorized party and would defeat traffic analysis. The interval in which messages are sent from the device may be continuous, in a consistent burst, or at some other predetermined amount of time. Dummy messages may also be sent at the predetermined interval in order to mask when messages or traffic regarding a detecting change to a device in the system occurs.

The system computer of the complex computer system receives the encrypted message from the device through the network and decrypts the message (step 204), for example through the system message program 68. The network may be network 50. If public key cryptography was used to encrypt the message, the system computer 57 will use its private key to decrypt the message.

If the message does not contain information or data regarding a change to the device (step 205), the method returns to step 202 of a device sending encrypted messages through the network to a system computer.

If the message does contain information or data regarding a change to the device (step 205), the system computer compares the data content of the decrypted message regarding the change to the device to the existing configuration data of the device or (step 206), for example through the system configuration compare program 66.

If the data content regarding a change to the device matches the existing configuration data for the device (step 208), then the system computer sends an encrypted message with the device's public key though the network to the device approving the change (step 212), for example through the system message program 68, allowing the change to be executed or take place to the device. It should be noted that as with the messages being sent from the device 52 to the system computer 57, the messages from the system computer 57 to the device 52 are sent with other encrypted messages and may be sent at an interval from the system computer that would not raise suspicion of an unauthorized party using traffic analysis. The matching of a change with the existing configuration data may occur, for example when there was a scheduled change that had been approved and the configuration of the device was updated prior to a technician altering the device. The method then continues to step 202 of the device sending encrypted messages through a network to a system computer through the device message program 67.

If the content regarding a change to the device does not match the existing configuration data for the device (step 208), and it is determined that based on the data content that does not match the existing configuration data that additional messages are to be sent to the device (step 210), then a message is encrypted using the public key specific to the device and sent through the network 50 to the device at an interval so as to defeat traffic analysis as discussed above, approving the execution of the change to the device. The system computer updates the existing configuration data of the device and stores the updated existing configuration in the repository (step 220), for example repository 53. The encrypted message is preferably sent using the system message program 68. The system configuration compare program 66 preferably updates and stores the updated data regarding the configuration for the device.

Then, the device 52 receives the encrypted message through the network 50, decrypts the message using the private key specific to the device, and the device allows the change to the device to be executed (step 222). The device may receive and decrypt the message from the system computer through the device message program 67. The method then continues to step 202 of the device sending encrypted messages through a network to a system computer through the device message program 67.

If the content regarding a change to the device does not match the existing configuration data for the device (step 208), and it is determined based on the data content that does not match the existing configuration data of the device, that no additional messages are to be sent to the device (step 210), and that the device is to be cut from the network data processing system or complex system 151 (step 214), then a notification is sent to an authorized user regarding the change to the device (step 216), to allow further investigation to take place. The notification may be encrypted using conventional encryption techniques.

If the system computer is still going to monitor the device (step 218), the method then continues to step 202 of the device sending encrypted messages through a network to a system computer through the device message program 67. This step may take place if the system computer wishes to monitor what changes are being requested for the device without alerting an unauthorized party or user.

If the system computer is not going to monitor the device (step 218), the method ends.

If the content regarding a change to the device does not match the existing configuration data for the device (step 208), and it is determined based on the data content that does not match the configuration data that no additional messages are to be sent to the device (step 210), and that the device is not to be cut or removed from the network data processing system or complex system (step 214), then the method returns to step 202 of the device sending encrypted messages through a network to a system computer through the device message program 67.

FIG. 7 illustrates internal and external components of device computer 52, system computer 57, and server computer 54 in which illustrative embodiments may be implemented. In FIG. 7, device computer 52, server computer 54, and the system computer 57 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, a system configuration compare program 66 are stored on one or more of the computer-readable tangible storage devices 830 for execution by one or more of the processors 820 via one or more of the RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. A device message program 67, system configuration compare program 66, and the system message program 68 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. A device message program 67, system configuration compare program 66, and the system message program 68 can be downloaded to device computer 52, the system computer 57 and server computer 54 from an external computer via a network (for example, the Internet, a local area network or other, wide area network) and network adapter or interface 836. From the network adapter or interface 836, a system computer 57 is loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

A device message program 67, system configuration compare program 66, and the system message program 68 can be written in various programming languages including low-level, high-level, object-oriented or non object-oriented languages. Alternatively, the functions of a device message program 67, system configuration compare program 66, and the system message program 68 can be implemented in whole or in part by computer circuits and other hardware (not shown).

Based on the foregoing, a computer system, method, and program product have been disclosed for detection of changes in hardware, software, or programming of a device in a computer system by a computer in the computer system coupled to the device through a network, without generating alerts or alerting unauthorized users of the detection of the changes. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method of detection of changes in hardware, software, or programming of a device in a computer system by a computer in the computer system coupled to the device through a network, without generating alerts or alerting unauthorized users of the detection of the changes, comprising the steps of:
the computer coupled to the device receiving at least one encrypted message from the device, the message having at least data regarding a change of hardware, software, or programming of the device;
the computer decrypting the message from the device to obtain the data regarding a change of hardware, software, or programming of the device from a device;
the computer comparing an existing configuration of the programming, software and hardware of the device to the data regarding the change of hardware, software, or programming of the device from the message to obtain differences between the existing configuration of the device and the data regarding the change of hardware, software, or programming of the device;
if differences are present between the existing configuration of the device and the data regarding the change of hardware, software, or programming of the device, the computer:
determining whether additional messages are to be sent to the device, and if additional messages are to be sent:
the computer generates and sends an encrypted message approving the change to the device, such that change to the device takes place; and
the computer updates the existing configuration to include the approved changes.

2. The method of claim 1, wherein encrypted messages between the device and computer are sent over a separate secured communications network.

3. The method of claim 1, wherein the encrypted messages between the device and the computer are sent at an established interval with other encrypted messages that have data relating to information other than a change to the device.

4. The method of claim 1, wherein the computer is coupled to a plurality of devices, and the computer identifies which device the encrypted message is received from through an IP address of the device.

5. The method of claim 1, wherein the computer is coupled to a plurality of devices, and when the computer decrypts a message from a device, the method further comprises the step of:
decrypting the message using the private key.

6. The method of claim 1, wherein when the computer encrypts a message to be sent to the device, the method further comprises the steps of:
using the IP address of the device in which a message is to be sent to look up a public key in a repository associated with the device; and
encrypting the message using the public key specific to the IP address of the device.

7. A computer program product for detection of changes in hardware, software, or programming of a device in a computer system by a computer in the computer system coupled to the device through a network, without generating alerts or alerting unauthorized users of the detection of the changes, the computer program product comprising:
one or more computer-readable, tangible storage devices;
program instructions, stored on at least one of the one or more storage devices, for the computer to receive at least one encrypted message from the device, the message having at least data regarding a change of hardware, software, or programming of the device;
program instructions, stored on at least one of the one or more storage devices for the computer, to decrypt the message from the device to obtain the data regarding a change of hardware, software, or programming of the device from a device;
program instructions, stored on at least one of the one or more storage devices for the computer, to compare an existing configuration of the programming, software and hardware of the device to the data regarding the change of hardware, software, or programming of the device from the message to obtain differences between the existing configuration of the device and the data regarding the change of hardware, software, or programming of the device;
if differences are present between the existing configuration of the device and the data regarding the change of hardware, software, or programming of the device, program instructions, stored on at least one of the one or more storage devices for the computer, to:
determine whether additional messages are to be sent to the device, and if additional messages are to be sent:
program instructions, stored on at least one of the one or more storage devices for the computer, to generate and send an encrypted message approving the change to the device, such that change to the device takes place; and
program instructions, stored on at least one of the one or more storage devices for the computer, to update the existing configuration to include the approved changes.

8. The computer program product of claim 7, wherein encrypted messages between the device and computer are sent over a separate secured communications network.

9. The computer program product of claim 7, wherein the encrypted messages between the device and the computer are sent at an established interval with other encrypted messages that have data relating to information other than a change to the device.

10. The computer program product of claim 7, wherein the computer is coupled to a plurality of devices, and the computer identifies which device the encrypted message is received from through an IP address of the device.

11. The computer program product of claim 7, wherein the computer is coupled to a plurality of devices, and when the computer executes program instructions, stored on at least one of the one or more storage devices, to decrypt a message from a device, the computer program product further comprises program instructions, stored on at least one of the one or more storage devices for the computer, to:
decrypt the message using a private key.

12. The computer program product of claim 7, wherein when the computer executes program instructions, stored on at least one of the one or more storage devices, to encrypt a message to be sent to the device, the computer program product further comprises program instructions, stored on at least one of the one or more storage devices for the computer to:
use the IP address of the device in which a message is to be sent to look up a public key in a repository associated with the device; and
encrypt the message using the public key specific to the IP address of the device.

13. A system for detection of changes in hardware, software, or programming of a device in a computer system by a computer in the computer system coupled to the device through a network, without generating alerts or alerting unauthorized users of the detection of the changes, the system comprising:
one or more processors, one or more computer-readable memories and one or more computer-readable, tangible storage devices;
program instructions, stored on at least one of the one or more storage devices for execution by at least one of the one or more processors via at least one of the one or more memories for the computer, to receive at least one encrypted message from the device, the message having at least data regarding a change of hardware, software, or programming of the device;
program instructions, stored on at least one of the one or more storage devices for execution by at least one of the one or more processors via at least one of the one or more memories for the computer, to decrypt the message from the device to obtain the data regarding a change of hardware, software, or programming of the device from a device;
program instructions, stored on at least one of the one or more storage devices for execution by at least one of the one or more processors via at least one of the one or more memories for the computer, to compare an existing configuration of the programming, software and hardware of the device to the data regarding the change of hardware, software, or programming of the device from the message to obtain differences between the existing configuration of the device and the data regarding the change of hardware, software, or programming of the device;
if differences are present between the existing configuration of the device and the data regarding the change of hardware, software, or programming of the device, program instructions, stored on at least one of the one or more storage devices for execution by at least one of the one or more processors via at least one of the one or more memories for the computer, to:
determine whether additional messages are to be sent to the device, and if additional messages are to be sent:
program instructions, stored on at least one of the one or more storage devices for execution by at least one of the one or more processors via at least one of the one or more memories for the computer, to generate and send an encrypted message approving the change to the device, such that change to the device takes place; and
program instructions, stored on at least one of the one or more storage devices for execution by at least one of the one or more processors via at least one of the one or more memories for the computer, to update the existing configuration to include the approved changes.

14. The system of claim 13, wherein encrypted messages between the device and computer are sent over a separate secured communications network.

15. The system of claim 13, wherein the encrypted messages between the device and the computer are sent at an established interval with other encrypted messages that have data relating to information other than a change to the device.

16. The system of claim 13, wherein the computer is coupled to a plurality of devices, and the computer identifies which device the encrypted message is received from through an IP address of the device.

17. The system of claim 13, wherein the computer is coupled to a plurality of devices, and when the computer executes program instructions, stored on at least one of the one or more storage devices for execution by at least one of the one or more processors via at least one of the one or more memories for the computer, to decrypt a message from a device, the computer program product further comprises program instructions, stored on at least one of the one or more storage devices for execution by at least one of the one or more processors via at least one of the one or more memories for the computer, to:
decrypt the message using a private key.

18. The system of claim 13, wherein when the computer executes program instructions, stored on at least one of the one or more storage devices for execution by at least one of the one or more processors via at least one of the one or more memories for the computer, to encrypt a message to be sent to the device, the computer program product further comprises program instructions, stored on at least one of the one or more storage devices for execution by at least one of the one or more processors via at least one of the one or more memories for the computer, to:
use the IP address of the device in which a message is to be sent to look up a public key in a repository associated with the device; and
encrypt the message using the public key specific to the IP address of the device.
